(19) United States
(12) Patent Application Publication
(10) Pub. No.: US 2023/0323905 A1
(43) Pub. Date: Oct. 12, 2023

(54) Fastener

(71) Applicant: Illinois Tool Works Inc., Glenview, IL (US)

(72) Inventor: Jiahui HE, Shanghai (CN)

(21) Appl. No.: 18/130,563

(22) Filed: Apr. 4, 2023

(30) Foreign Application Priority Data
Apr. 6, 2022 (CN) 2022103581966
Mar. 22, 2023 (CN) 2023102846305

(51) Int. Cl. F16B 5/07; F16B 39/28

(52) U.S. Cl. CPC F16B 5/07; F16B 39/28

(57) ABSTRACT

The present application relates to a fastener for insertion into a first through hole in a rectangular shape on a first plate, and the fastener includes a head, a body, at least two resilient arms, and at least two anti-rotation portions. The body is disposed below the head. At least two resilient arms are provided on opposite first side and second side of the body, respectively, and connect the first side and the second side of the body to the head, respectively. The at least two anti-rotation portions protrude from the first side and the second side of the body, respectively. The at least two anti-rotation portions are configured to be located in the first through hole when the fastener is inserted into the first plate and mounted in place, and each of the at least two anti-rotation portions mates with two adjacent edges of the first through hole to impede rotation of the fastener relative to the first plate. The fastener of the present application can prevent the fastener from rotating relative to the first plate during mounting and can better clamp the first plate.

### RELATED APPLICATIONS

The present application claims the benefit of Chinese Patent Application Nos. 2022103581966, filed Apr. 6, 2022, and 2023102846305, filed Mar. 22, 2023, each titled “Fastener,” the contents of which are hereby incorporated by reference.

### BACKGROUND

When a first plate and a second plate are connected, an operator snaps a fastener into the first plate, then places the second plate over the fastener and screws a connector (e.g., a screw). However, the fastener may not fit well with the first plate, especially when the connector is screwed in, the fastener will rotate relative to the first plate, causing slipping and other problems.

### SUMMARY

The present application provides a fastener for insertion into a first through hole in a rectangular shape on a first plate, and the fastener includes a head, a body, at least two resilient arms, and at least two anti-rotation portions. The body is disposed below the head. At least two resilient arms are provided on opposite first side and second side of the body, respectively, and connect the first side and the second side of the body to the head, respectively. The at least two anti-rotation portions protrude from the first side and the second side of the body, respectively. The at least two anti-rotation portions are configured to be located in the first through hole when the fastener is inserted into the first plate and mounted in place, and each of the at least two anti-rotation portions mates with two adjacent edges of the first through hole to impede rotation of the fastener relative to the first plate.

According to the fastener described above, the body further includes a third side and a fourth side disposed oppositely. The third side, the first anti-rotation portion first side, and the second anti-rotation portion first side are disposed in a same plane and mate with one edge of the first through hole.

According to the fastener described above, the first anti-rotation portion further includes a first anti-rotation portion second side, and the second anti-rotation portion further includes a second anti-rotation portion second side. The first anti-rotation portion and the second anti-rotation portion are configured so that the first anti-rotation portion first side and the first anti-rotation portion second side mate with two adjacent edges of one corner of the first through hole when the fastener is inserted into the first plate and mounted in place, and the second anti-rotation portion second side and the second anti-rotation portion first side mate with two adjacent edges of another corner of the first through hole. A distance between the first anti-rotation portion second side and the second anti-rotation portion second side is not less than a distance between the third side and the fourth side.

According to the fastener described above, proximal ends of the at least two resilient arms are connected to the first side and the second side of the body, respectively, and distal ends of the at least two resilient arms are connected to the head. The at least two anti-rotation portions are located outside distal ends of resilient arms on respective sides.

According to the fastener described above, the head is provided with a hollow portion running through the head. The body is movable relative to the head to enter the hollow portion.

According to the fastener described above, the body has a pre-mounting position and a mounting position and is movable between the pre-mounting position and the mounting position by movement. The fastener is configured to: a top surface of the body has a predetermined distance from a top surface of the head when the body is located in the pre-mounting position, and the top surface of the body is flush with the top surface of the head when the body is located in the mounting position and is able to abut a second plate together.

According to the aforementioned fasteners, the body is provided with a connecting hole, the connecting hole is recessed downwards from an upper surface of the body, and an inner surface of the connecting hole is provided with internal threads for mating with external threads on a connecting member.

According to the fastener described above, the at least two resilient arms are configured to: as mating of the external threads and the internal threads drives the body to move from the pre-mounting position to the mounting position, enter the hollow portion.

According to the fastener described above, a clamping portion is provided on each of the at least two resilient arms. The at least two resilient arms are configured to: when the body moves from the pre-mounting position to the mounting position, the at least two resilient arms deform, and the clamping portion clamps the first plate with the head.

According to the fastener described above, the clamping portion includes several steps provided on an outer surface of the resilient arm.

The present application further provides a fastener for insertion into a first through hole in a rectangular shape on a first plate, and the fastener includes a head, a body, two resilient arms, and four anti-rotation portions. The body is disposed below the head. The two resilient arms are provided on opposite first side and second side of the body, respectively, and connect the first side and the second side of the body to the head, respectively. Two of the four anti-rotation portions protrude from the first side of the body, and the other two of the four anti-rotation portions protrude from the second side of the body. The four anti-rotation portions are configured to be located in the first through hole when the fastener is inserted into the first plate and mounted in place, and each of the four anti-rotation portions mates with two adjacent edges of the first through hole to impede rotation of the fastener relative to the first plate.

The fastener of the present application can prevent the fastener from rotating relative to the first plate during mounting and can better clamp the first plate.

The concepts, specific structures, and technical effects of the present application will be further explained below in conjunction with the appended drawings to fully understand the purpose, features, and effects of the present application.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1A-1C are perspective views of a fastener of the present application looking from different directions.

FIG. 1D is a cross-sectional view of the fastener shown in FIG. 1A with a body of the fastener located in a pre-mounting position;

FIG. 1E is a cross-sectional view of the fastener shown in FIG. 1A with the body of the fastener located in a mounting position.

FIG. 2 is an exploded view of a fastener, a first plate, and a second plate of the present application.

FIGS. 3A-3D are mounting process status diagrams of a fastener.

### DETAILED DESCRIPTION

Various specific embodiments of the present application will be described below with reference to the attached drawings that form a part of the present specification. It should be understood that while terms denoting orientation, such as “upper,” “lower,” “left,” “right,” “front,” “rear,” etc., are used in the present application to describe various exemplary structural parts and elements of the present application, these terms are used herein for convenience of illustration only, and these terms are determined based on the exemplary orientations shown in the attached drawings. Since the examples disclosed in the present application may be disposed in different orientations, these terms denoting orientation are for illustrative purposes only and should not be considered as limiting.

It should be understood that ordinal words such as “first” and “second” used in this application are used for distinction and identification only and have no other meaning, and do not represent a particular order or association unless specifically specified. For example, the term “first resilient arm” by itself does not imply the presence of a “second resilient arm” and the term “second resilient arm” by itself does not imply the presence of the “first resilient arm.”

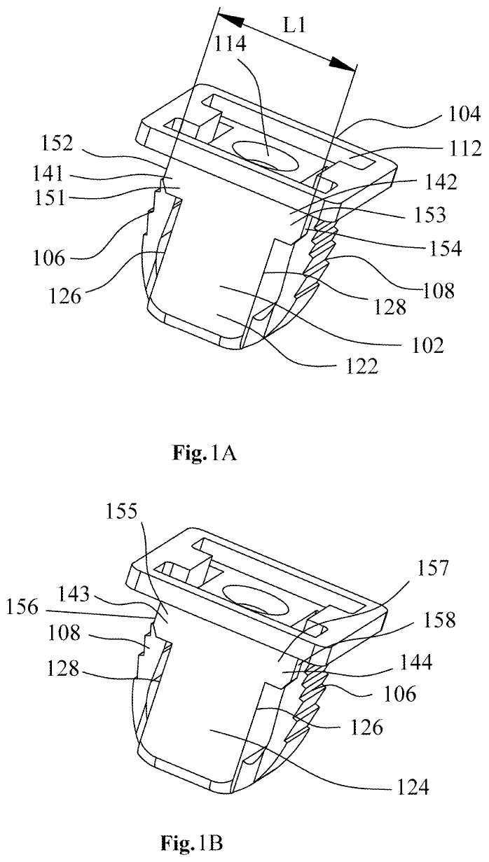

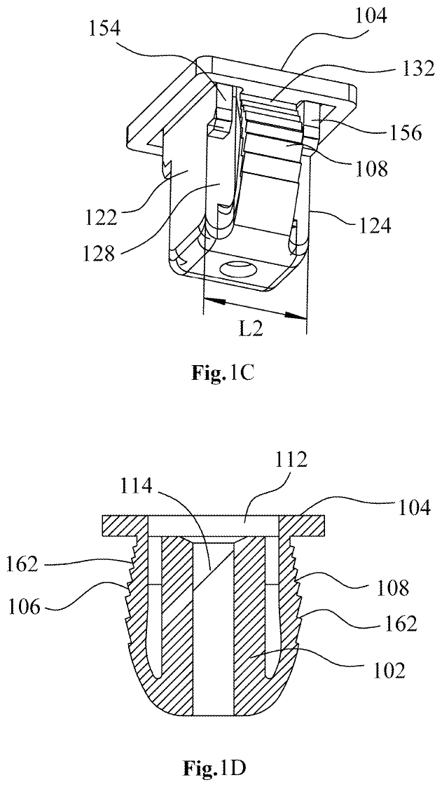

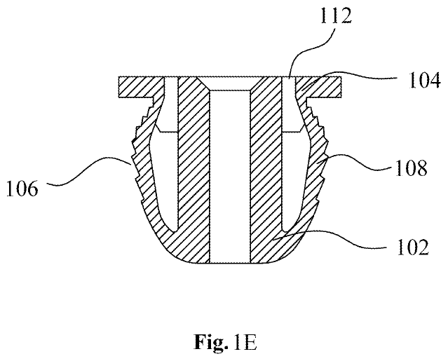

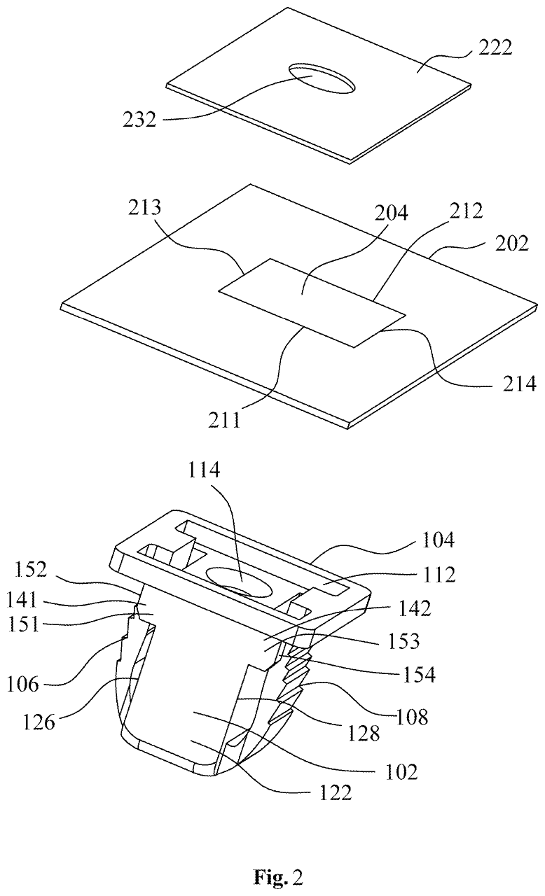

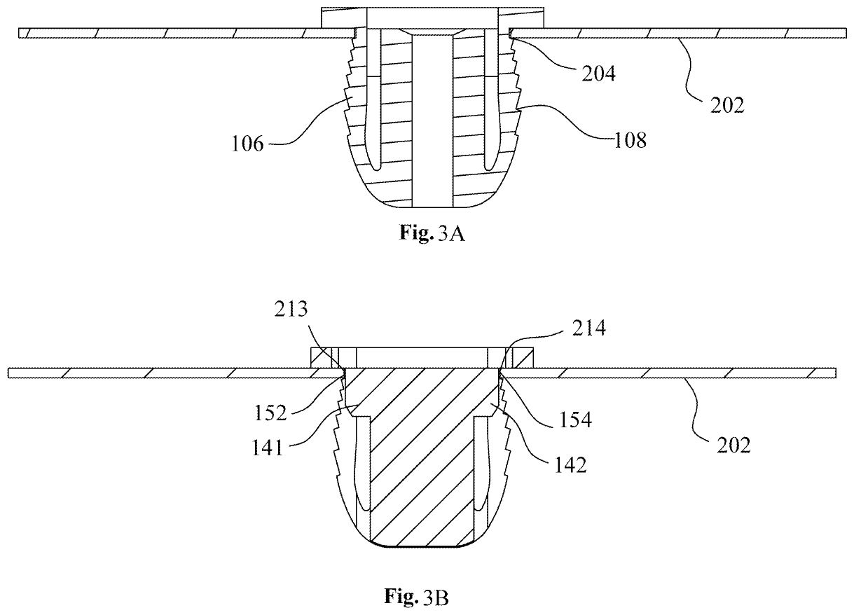

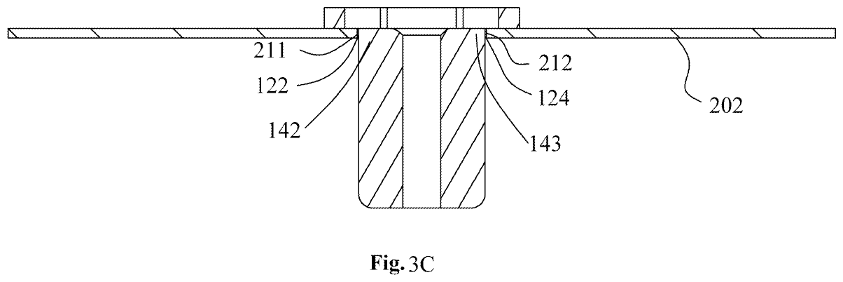

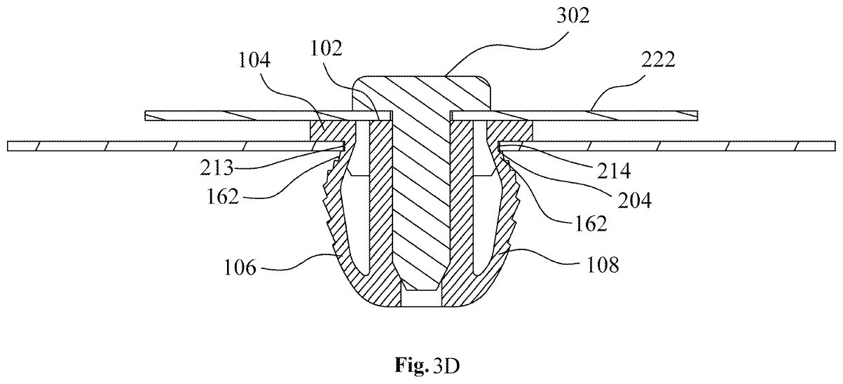

FIGS. 1A-1B are perspective views of a fastener of the present application looking from different directions. FIG. 1A is a perspective view of the fastener of the present application looking from the front, and FIG. 1B is a perspective view of the fastener shown in FIG. 1A looking from the rear. The fastener of the present application is capable of mating with a connector 302 (see FIG. 3D) to connect a first plate 202 (see FIG. 2) and a second plate 222 (see FIG. 2). A first through hole 204 in the shape of a rectangle is provided on the first plate 202.

As shown in FIGS. 1A-1B, the fastener includes a body 102, a head 104, a first resilient arm 106, a second resilient arm 108, and four anti-rotation portions. In one example of the present application, the body 102, the head 104, the first resilient arm 106, the second resilient arm 108, and the four anti-rotation portions are integrally formed. The head 104 is substantially rectangular in the shape of a plate. The body 102 is substantially a square body that extends in an up-down direction. The body 102 is disposed below the head 104. The body 102 has opposite first side (i.e., left side) and second side (i.e., right side) 126 and 128, and opposite third side (i.e., front side) and fourth side (i.e., back side) 122 and 124. The first side 126, the third side 122, the second side 128, and the fourth side 124 sequentially enclose to form four sides of the body 102. The four anti-rotation portions are a first anti-rotation portion 141, a second anti-rotation portion 142, a third anti-rotation portion 143 and a fourth anti-rotation portion 144, respectively. The four anti-rotation portions are respectively provided at four corners of the body 102 and are generally provided at an upper portion of the body 102. The first and second resilient arms 106, 108 are disposed on the first and second sides 126, 128 and connect the first and second sides 126, 128 of the body 102 to the head 104, respectively. The size of the head 104 is larger than the size of the first through hole 204 on the first plate 202 (see FIG. 2), and the size of the head 104, the first resilient arm 106, the second resilient arm 108, and the four anti-rotation portions match the size of the first through hole 204, so that when the fastener is inserted into the first through hole 204 of the first plate 202 and is mounted in place, the head 104, the first resilient arm 106, the second resilient arm 108, and the four anti-rotation portions can pass through the first through hole 204 and be located in the first through hole 204, and the head 104 can remain above the first through hole 204 to prevent the fastener from moving downwards to release from the first through hole 204. When the fastener is inserted into the first through hole 204 of the first plate 202 and mounted in place, the four anti-rotation portions are respectively located in the first through hole 204, and are at four corners of the first through hole 204, and mate with the four corners of the first through hole 204. More specifically, each of the four anti-rotation portions mates with two adjacent edges of the first through hole 204 to impede rotation of the fastener relative to the first plate 202.

Specifically, the first and fourth anti-rotation portions 141, 144 protrude from the first side 126 of the body 102 and the second and third anti-rotation portions 142, 143 protrude from the second side 128 of the body 102. The first anti-rotation portion 141 includes a first anti-rotation portion first side 151 and a first anti-rotation portion second side 152. The first anti-rotation portion first side 151 and the first anti-rotation portion second side 152 are arranged substantially at right angles. The second anti-rotation portion 142 includes a second anti-rotation portion first side 153 and a second anti-rotation portion second side 154. The second anti-rotation portion first side 153 and the second anti-rotation portion second side 154 are arranged substantially at right angles. The first anti-rotation portion first side 151 and the second anti-rotation portion first side 153 are disposed forwards and are disposed in the same plane as the third side 122 of the body 102 and mate with one edge (e.g., a front edge) of the first through hole 204. The third anti-rotation portion 143 includes a third anti-rotation portion first side 155 and a third anti-rotation portion second side 156. The third anti-rotation portion first side 155 and the third anti-rotation portion second side 156 are arranged substantially at right angles. The fourth anti-rotation portion 144 includes a fourth anti-rotation portion first side 157 and a fourth anti-rotation portion second side 158. The fourth anti-rotation portion first side 157 and the fourth anti-rotation portion second side 158 are arranged substantially at right angles. The third anti-rotation portion first side 155 and the fourth anti-rotation portion first side 157 are disposed rearwards and are disposed in the same plane as the fourth side 124 of the body and mate with one edge (e.g., a rear edge) of the first through hole 204. Further, the first anti-rotation portion second side 152 and the fourth anti-rotation portion second side 158 are disposed towards the left and are disposed in the same plane and mate with one edge (e.g., a left edge) of the first through hole 204. The second anti-rotation portion second side 154 and the third anti-rotation portion second side 156 are disposed towards the right and are disposed in the same plane and mate with one edge (e.g., a right edge) of the first through hole 204. A distance between the first anti-rotation portion second side 152 and the second anti-rotation portion second side 154 is a first distance L1. A distance between the third side 122 and the fourth side 124 is a second distance L2 (see FIG. 1C). The first distance L1 is not less than the second distance L2.

FIG. 1C is a perspective view of the fastener shown in FIG. 1A looking from the right. As shown in FIGS. 1A-1C, proximal ends (i.e., lower ends) of the first and second resilient arms 106, 108 are respectively connected to the first and second sides 126, 128 of the body 102, and distal ends (i.e., upper ends) of the first and second resilient arms 106, 108 are respectively connected to the head 104. The first anti-rotation portion 141 and the fourth anti-rotation portion 144 are respectively located outside the distal end of the first resilient arm 106, and the second anti-rotation portion 142 and the third anti-rotation portion 143 are respectively located outside the distal end of the second resilient arm 108. Because the first distance L1 is not less than the second distance L2, the first resilient arm 106 and the second resilient arm 108 are disposed on shorter sides of the body 102.

Furthermore, a clamping portion is provided on each of the first and second resilient arms 106, 108 for clamping the first plate 202 together with the head 104. In particular, the clamping portion includes several steps 162 provided on outer surfaces of the first resilient arm 106 and the second resilient arm 108. In other words, the several steps 162 form a serrated shape.

The body 102 of the fastener of the present application is movable relative to the head 104 and has a pre-mounting position and a mounting position. The body 102 is movable between the pre-mounting position and the mounting position by movement.

FIG. 1D is a cross-sectional view of the fastener shown in FIG. 1A, with the body 102 in the pre-mounting position; FIG. 1E is a cross-sectional view of the fastener shown in FIG. 1A, with the body 102 in the mounting position. As shown in FIGS. 1D-1E, the head 104 is provided with a hollow portion 112 running through the head 104. The body 102 is movable relative to the head 104 to enter and exit the hollow portion 112. The first resilient arm 106 and the second resilient arm 108 are configured to be capable of deforming (i.e., deformation) to allow movement of the body 102 relative to the head 104.

In particular, a connecting hole 114 is provided on the body 102. The connecting hole 114 runs through the body 102 in an up-down direction. An inner surface of the connecting hole 114 is provided with internal threads (not shown) for mating with external threads (not shown) of the connector 302 (see FIG. 3D). As the connector 302 extends into the connecting hole 114 and rotates relative to the body 102, due to the mating of the external threads of the connector 302 with the internal threads in the connecting hole 114, the rotation of the connector 302 will drive the body 102 to move upwardly relative to the head 104 and enter into the hollow portion 112. As shown in FIG. 1D, the body 102 is located in a pre-mounting position. In this case, the top surface of the body 102 has a predetermined distance from the top surface of the head 104. As shown in FIG. 1E, the body 102 is located in the mounting position. In this case, the body 102 enters the hollow portion 112 and the top surface of the body 102 is flush with the top surface of the head 104. Furthermore, during movement of the body 102 from the pre-mounting position to the mounting position, the middle portions of the first resilient arm 106 and the second resilient arm 108 are remote from the body 102, respectively, so that several steps 162 are close to the head 104 in an up-down direction.

FIG. 2 is an exploded view of the fastener, the first plate 202, and the second plate 222 of the present application. As shown in FIG. 2, the first plate 202 is substantially a plate. A first through hole 204 in the shape of a rectangle is provided on the first plate 202. The first through hole 204 has a first edge 211, a second edge 212, a third edge 213, and a fourth edge 214, which face the front, rear, left, and right, respectively. The first edge 211, the fourth edge 214, the second edge 212, and the third edge 213 sequentially enclose to form four corners adjacent to each other. The four anti-rotation portions of the fastener can mate with the four corners of the first through hole 204, thereby preventing the fastener from rotating relative to the first plate 202. The second plate 222 is substantially a plate. The second plate 222 is provided with a second through hole 232 that is substantially circular for receiving the connector 302 (see FIG. 3D).

FIGS. 3A-3D are mounting process status diagrams of a fastener. FIGS. 3A-3C illustrate the mounting status of the fastener and the first plate 202. FIG. 3A is a first cross-sectional view of the fastener and the first plate 202 to show the positional relationship of the first resilient arm 106 and the second resilient arm 108 with the first through hole 204; FIG. 3B is a second cross-sectional view of the fastener and the first plate 202 to show the positional relationship of the first anti-rotation portion 141 and the second anti-rotation portion 142 with the first through hole 204; FIG. 3C is a third cross-sectional view of the fastener and the first plate 202 to show the positional relationship of the second anti-rotation portion 142 and the third anti-rotation portion 143 with the first through hole 204. As shown in FIGS. 3A-3C, the body 102, the first resilient arm 106, the second resilient arm 108, and the four anti-rotation portions of the fastener are located in the first through hole 204, and the body 102 is located in the pre-mounting position. The first anti-rotation portion first side 151, the third side 122, and the second anti-rotation portion first side 153 are located in the same plane and mate with the first edge 211 together, and the third anti-rotation portion first side 155, the fourth side 124, and the fourth anti-rotation portion first side 157 located in the same plane and mate with the second edge 212 together, so that the opposite first edge 211 and second edge 212 of the first through hole 204 are abutted by the fastener along the entire length. The first anti-rotation portion second side 152 and the fourth anti-rotation portion second side 158 are located in the same plane and mate with the third edge 213 together, and the second anti-rotation portion second side 154 and the third anti-rotation portion second side 156 are located in the same plane and mate with the fourth edge 214 together, so that both end portions of the third edge 213 and the fourth edge 214 are abutted by the fastener along the entire length of the opposite third edge 213 and fourth edge 214 of the first through hole 204. As such, the four anti-rotation portions are located at the four corners of the first through hole 204, respectively, and each anti-rotation portion mates with two adjacent edges in the first through hole 204 to prevent the fastener from rotating relative to the first plate 202.

FIG. 3D shows the mounting status of the fastener with the first plate 202, the connector 302, and the second plate 222 to show the positional relationship of the first resilient arm 106 and the second resilient arm 108 with the first through hole 204. As shown in FIG. 3D, the body 102 is located in a mounting position. The top surface of the body 102 and the top surface of the head 104 abut the second plate 222. The distal ends (i.e., the upper ends) of the first and second resilient arms 106, 108 can abut the third and fourth edges 213, 214 of the first through hole 204, respectively. The bottom surface of the head 104 abuts the upper surface of the first plate 202, and one of the several steps 162 abuts the lower surface of the first plate 202, causing the head 104 and the step 162 to clamp the first plate 202 to prevent the first plate 202 from releasing from the fastener downwards.

The mounting process of mounting the first plate 202 and the second plate 222 together by the fastener and connector 302 is described below with reference to FIGS. 3A-3D:

First, as shown in FIGS. 3A-3C, an operator tucks the fastener into the first through hole 204 of the first plate 202 and makes the bottom surface of the head 104 to abut the upper surface of the first plate 202. The operator then places the second plate 222 over the head 104 and aligns the second through hole 232 generally with the connecting hole 114 on the body 102. The operator then screws the connector 302 downwards into the second through hole 232 and the connecting hole 114. The mating between the external threads of the connector 302 and the internal threads in the connecting hole 114 will, on the one hand, drive the body 102 to move upwards relative to the head 104, so that the top surface of the body 102 abuts the lower surface of the second plate 222, on the other hand, cause the middle portions of the first resilient arm 106 and the second resilient arm 108 to move outwardly away from the body 102, so that one of the several steps 162 abuts the lower surface of the first plate 202. As such, the head 104 and the step 162 clamp the first plate 202, and the fastener and the connector 302 clamp the second plate 222, thereby connecting the first plate 202 and the second plate 222 together.

It should be noted that although the examples of the present application show that the first anti-rotation portion first side 151, the third side 122 and the second anti-rotation portion first side 153 are located in the same plane, and the third anti-rotation portion first side 155, the fourth side 124 and the fourth anti-rotation portion first side 157 are located in the same plane, in other examples, the first anti-rotation portion first side 151 and the second anti-rotation portion first side 153 are located in the same plane, and the third anti-rotation portion first side 155 and the fourth anti-rotation portion first side 157 are located in the same plane.

It should be also noted that while four anti-rotation portions are shown in the examples of the present application, fasteners including at least two anti-rotation portions are all within the scope of protection of the present application.

The fastener of the present application can prevent rotation of the fastener relative to the first plate 202 during mounting. Specifically, the fastener of the present application mates with two adjacent edges in the first through hole 204 by providing an anti-rotation portion. At least two corners of the first through hole 204 are blocked by the anti-rotation portions of the fastener, thereby impeding rotation of the fastener relative to the first plate 202. Further, the fastener of the present application is also able to better clamp the first plate 202. Specifically, the body 102 of the present application is movable relative to the head 104 and is able to enter the hollow portion 112 over the head 104. The body 102 has a greater distance of motion in the up-down direction, which causes the first and second resilient arms 106, 108 to produce greater deformation, thereby causing the deformed first and second resilient arms 106, 108 to have greater force against the lower surface of the first plate 202 to hold the first plate 202 in place. Further, because the first and second resilient arms 106, 108 are capable of producing greater deformation, the fastener of the present application is also capable of holding the first plate 202 in place when the thickness of the first plate 202 is thinner, preventing it from being released from below the fastener.

It should be noted that while two resilient arms are shown in the examples of the present application, fasteners including at least two resilient arms are all within the scope of protection of the present application.

It should also be noted that although the connecting hole 114 is provided running through the body 102 in the examples of the present application, in other examples, the connecting hole 114 may be concavely formed downwardly from the upper surface of the body 102.

It should also be noted that, although the clamping portion is introduced in the examples of the present application using several steps 162 as an example, those skilled in the art can understand that the clamping portion configured to abut the first plate 202 from below is also within the scope of protection of the present application.

Although the present disclosure has been described in connection with examples of the examples outlined above, various alternatives, modifications, variations, improvements, and/or substantial equivalents, whether known or foreseeable now or in the near future, may be apparent to those having at least ordinary skill in the art. In addition, the technical effects and/or technical problems described in the present specification are exemplary and not limiting; therefore, the disclosure in the present specification may be used to solve other technical problems and have other technical effects and/or may solve other technical problems. Therefore, examples of the present disclosure as set forth above are intended to be illustrative and not limiting. Various changes may be made without departing from the spirit or scope of the present disclosure. Therefore, the present disclosure is intended to include all known or earlier developed alternatives, modifications, variations, improvements and/or substantial equivalents.

What is claimed is:

1. A fastener, wherein the fastener is configured to insert a first through hole (204) in a rectangular shape on a first plate (202), and the fastener comprises:
a head (104);
a body (102) disposed below the head (104);
at least two resilient arms disposed on opposite first side (126) and second side (128) of the body (102), respectively, and connecting the first side (126) and the second side (128) of the body (102) to the head (104), respectively; and
at least two anti-rotation portions protruding from the first side (126) and the second side (128) of the body (102), respectively;
wherein the at least two anti-rotation portions are configured to be located in the first through hole (204) when the fastener is inserted into the first plate (202) and mounted in place, and each of the at least two anti-rotation portions mates with two adjacent edges of the first through hole (204) to impede rotation of the fastener relative to the first plate (202).

2. The fastener according to claim 1, wherein:
the at least two anti-rotation portions comprise a first anti-rotation portion (141) comprising a first anti-rotation portion first side (151) and a second anti-rotation portion (142) comprising a second anti-rotation portion first side (153);
wherein the first anti-rotation portion first side (151) and the second anti-rotation portion first side (153) are disposed in a same plane and mate with one edge of the first through hole (204).

3. The fastener according to claim 2, wherein:
the body (102) further comprises a third side (122) and a fourth side (124) disposed oppositely; and
the third side (122), the first anti-rotation portion first side (151), and the second anti-rotation portion first side (153) are disposed in a same plane and mate with one edge of the first through hole (204).

4. The fastener according to claim 3, wherein:
the first anti-rotation portion (141) further comprises a first anti-rotation portion second side (152), and the second anti-rotation portion (142) further comprises a second anti-rotation portion second side (154);
the first anti-rotation portion (141) and the second anti-rotation portion (142) are configured so that the first anti-rotation portion first side (151) and the first anti-rotation portion second side (152) mate with two adjacent edges of one corner of the first through hole (204) when the fastener is inserted into the first plate (202) and mounted in place, and the second anti-rotation portion second side (154) and the second anti-rotation portion first side (153) mate with two adjacent edges of another corner of the first through hole (204); and
a distance between the first anti-rotation portion second side (152) and the second anti-rotation portion second side (154) is not less than a distance between the third side (122) and the fourth side (124).

5. The fastener according to claim 1, wherein:
proximal ends of the at least two resilient arms are connected to the first side (126) and the second side (128) of the body (102), respectively, and distal ends of the at least two resilient arms are connected to the head (104); and
the at least two anti-rotation portions are located outside distal ends of resilient arms on respective sides.

6. The fastener according to claim 1, wherein:
the head (104) is provided with a hollow portion (112) running through the head (104); and
the body (102) is movable relative to the head (104) to enter the hollow portion (112).

7. The fastener according to claim 6, wherein:
the body (102) has a pre-mounting position and a mounting position and is movable between the pre-mounting position and the mounting position by movement; and
the fastener is configured to: a top surface of the body (102) has a predetermined distance from a top surface of the head (104) when the body (102) is located in the pre-mounting position, and the top surface of the body (102) is flush with the top surface of the head (104) when the body (102) is located in the mounting position and is able to abut a second plate (204) together.

8. The fastener according to claim 7, wherein:
the body (102) is provided with a connecting hole (114), the connecting hole (114) is recessed downwards from an upper surface of the body (102), and an inner surface of the connecting hole (114) is provided with internal threads for mating with external threads on a connecting member (302).

9. The fastener according to claim 8, wherein:
The at least two resilient arms are configured to: as mating of the external threads and the internal threads drives the body (102) to move from the pre-mounting position to the mounting position, enter the hollow portion (112).

10. The fastener according to claim 7, wherein:
a clamping portion is provided on each of the at least two resilient arms;
The at least two resilient arms are configured to: when the body (102) moves from the pre-mounting position to the mounting position, the at least two resilient arms deform, and the clamping portion clamps the first plate (202) with the head (104).

11. The fastener according to claim 10, wherein:
the clamping portion comprises several steps (162) provided on an outer surface of the resilient arm.

12. A fastener, wherein the fastener is configured to insert a first through hole (204) in a rectangular shape on a first plate (202), and the fastener comprises:
a head (104);
a body (102) disposed below the head (104);
two resilient arms disposed on opposite first side (126) and second side (128) of the body (102), respectively, and connecting the first side (126) and the second side (128) of the body (102) to the head (104), respectively; and
four anti-rotation portions, two of the four anti-rotation portions protruding from the first side (126) of the body (102), the other two of the four anti-rotation portions protruding from the second side (128) of the body (102),
wherein the four anti-rotation portions are configured to be located in the first through hole (204) when the fastener is inserted into the first plate (202) and mounted in place, and each of the four anti-rotation portions mates with two adjacent edges of the first through hole (204) to impede rotation of the fastener relative to the first plate (202).
